(19) United States
(12) Patent Application Publication
(10) Pub. No.: US 2003/0076789 A1
(43) Pub. Date: Apr. 24, 2003

(54) Network system, addressing method, communication control device and method thereof

(76) Inventors: Norihiko Kimura, Kanagawa (JP); Kuninori Shino, Tokyo (JP); Yoshinobu Kure, Kanagawa (JP)

Correspondence Address: FROMMER LAWRENCE & HAUG, 745 FIFTH AVENUE- 10TH FL., NEW YORK, NY, 10151, US

(21) Appl. No.: 10/228,004

(22) Filed: Aug. 26, 2002

(30) Foreign Application Priority Data
Aug. 27, 2001 (JP) 2001-256851

(51) Int. Cl. H04L 12/28

(52) U.S. Cl. 370/254; 709/318

(57) ABSTRACT

In a network system having a simple construction, addressing method, communication control device and method thereof, the increase or decrease in the number of nodes does not affect the nodes of a network. Each node is provided with a first storage means for storing first information indicating all node identifiers used in a network and second information indicating the node identifiers of all nodes directly or indirectly connected to each port, and when new nodes are connected to the network, a predetermined first node gives each of the new nodes a node identifier and notifies the other nodes of this information, and when nodes are disconnected from the network, a prescribed second node remaining in the network notifies the other nodes of this information.

### BACKGROUND OF THE INVENTION

1. Field of the Inevntion

This invention relates to a network system, addressing method, communication control device and method thereof, and more particularly, is suitably applied to a network having a spanning tree formation (a topology in which plural nodes are connected so as not to logically form loops).

2. Description of the Related Art

Various methods have been proposed as node-ID assignment methods (hereinafter, referred to as addressing method) for dynamically assigning node identifications (node IDs) according to increase or decrease in the number of nodes (information devices) of a network.

In actual, one of such addressing methods is an Institute of Electrical and Electronics Engineers (IEEE) 1394 method which deletes all topology (formation of connections) information about a network which each node stores, and remakes new topology information every time when the number of nodes increases or decreases in the network.

In addition, other addressing methods have been proposed, such as a Dynamic Host Configuration Protocol (DHCP) method for dynamically assigning an address space which is controlled by a special node, to nodes, and an ILMI method of Asynchronous Transfer Mode (ATM) for installing an address assignment mechanism on a special device and using a combination of a unique ID (hereinafter, referred to as UID) which is previously given to the device and a vender unique ID (hereinafter, referred to as a vender ID) of each node as an identifier.

This IEEE1394 method remakes topology information every time when the number of nodes increases or decreases as described above and interrupts data transfer between nodes during this processing, which results in failing the data transfer. This data failure is such a big problem, especially in real time distribution, that the distribution would stop or images would flick if the images were distributed in real time.

On the other hand, in the DHCP method, an administrator should previously keep an address space for use and in many cases, this address space is kept for the number of users more than expected, which causes a problem in that an address space which is actually available for assignment becomes small.

Furthermore, the ILMI method of ATM uses a long ID for each node, which causes a problem in that the storage of this ID is a waste of memory. In addition, this method requires a unit called a special switch having different functions from general nodes, which causes a problem in that the network is difficult to offer flexible expansion.

### SUMMARY OF THE INVENTION

In view of the foregoing, an object of this invention is to provide a network system having a simple construction, an addressing method, communication control device and method thereof which do not allow the increase or decrease in the number of nodes of a network to affect the nodes of a network.

The foregoing object and other objects of the invention have been achieved by the provision of a network system in which a network is composed without a logical loop of plural nodes each given a unique node identifier. Each node of the network system comprises a first storage means for storing first information indicating all node identifiers used in the network and a second storage means for storing second information indicating the node identifiers of all nodes which are directly or indirectly connected to each port. When new nodes are connected to the network, a first node previously selected from the nodes connected to the network gives each of the new nodes a node identifier and also notifies the other nodes of this information to make the other nodes update the first and/or second information. When nodes are disconnected from the network, a prescribed second node remaining in the network notifies the other nodes of this information to make the other nodes update the first and/or second information.

As a result, this network system is capable of performing addressing without effects of the connection or disconnection of nodes on information transmission between the other nodes, and does not require a special unit for addressing, thus making it possible to simplify the scale of the system.

Further, in this invention, an addressing method in a network which is composed so as not to have a logical loop of plural nodes each given a unique node identifier comprises the first step of making each node store first information indicating all node identifiers used in the network and second information indicating the node identifiers of all nodes directly or indirectly connected to each port of own node, and the second step at which, when new nodes are connected to the network, a first node previously selected from the nodes connected to the network gives each of the new nodes a node identifier and notifies the other nodes of this information to make the other nodes update the first and/or second information, and when nodes are disconnected from the network, a prescribed second node remaining in the network notifies the other nodes of this information to make the other nodes update the first and/or second information.

As a result, this addressing method is capable of performing addressing without any effects of the connection or disconnection of nodes on information transmission between the other nodes and does not require a special unit for addressing, thus making it possible to simplify the scale of the system.

Furthermore, this invention provides a communication control device with a first storage means for storing first information indicating all node identifiers used in a network to which own node is connected, a second storage means for storing second information indicating the node identifiers of all nodes directly or indirectly connected to each port of own node, a control means for controlling communications with another node based on the first and second information, and an updating means for updating the first and/or second information in accordance with the connection of new nodes to the network or the disconnection of nodes from the network.

As a result, this communication control device can update the first and second information in accordance with the connection of nodes to the network without any effects on information transmission between the other nodes.

Furthermore, this invention provides a communication control method with the first step of storing first information indicating all node identifiers used in the network to which own node is connected and second information indicating the node identifiers of all nodes directly or indirectly connected to each port of own node, and the second step of controlling communications with another node based on the first and second information and updating the first and/or second information in accordance with the connection of new nodes to the network or the disconnection of nodes from the network.

As a result, this communication control method can update the first and second information in accordance with the connection of nodes to the network without any effects on information transmission between the other nodes.

According to the present invention, in the network system, each node is provided with a first storage means for storing first information indicating all node identifiers used in the network and a second storage means for storing second information indicating the node identifiers of all nodes directly or indirectly connected to each port. When new nodes are connected to the network, a first node previously selected out of the nodes connected to the network gives each of the new nodes a node identifier, and notifies the other nodes of this information to make the other nodes update the first and/or second information. When nodes are disconnected from the network, a prescribed second node remaining in the network notifies the other nodes of this information to make the other nodes update the first and/or second information. Thereby, addressing can be performed without any effects of the connection or disconnection of nodes on information transmission between the other nodes, and also a special unit is not necessary for addressing, which can simplify the scale of the system, thus making it possible to realize the simple network system in which the increase or decrease in the number of nodes in the network does not affect the nodes of the network.

Further, in the present invention, the addressing method comprises a first step of making each node store first information indicating all node identifiers used in the network and second information indicating the node identifiers of all nodes directly or indirectly connected to each port of own node and a second step at which, when new nodes are connected to the network, a first node previously selected out of the nodes connected to the network gives each of the new nodes a node identifier and notifies the other nodes of this information to make the other nodes update the first and/or second information, and when nodes are disconnected from the network, a prescribed second node remaining in the network notifies the other nodes of this information to make the other nodes update the first and/or second information. Therefore, addressing can be performed without any effects of the connection or disconnection of nodes on information transmission between the other nodes, and a special unit is not necessary for addressing, which can simplify the scale of the system, thus making it possible to realize the simple network in which the increase or decrease in the number of nodes in the network does not affect the network nodes.

Still further, the communication control device of this invention is provided with a first storage means for storing first information indicating all node identifiers used in the network to which own node is connected, a second storage means for storing second information indicating the node identifiers of all nodes directly or indirectly connected to each port of own node, a control means for controlling communications with another node based on the first and second information, and an updating means for updating the first and/or second information in accordance with the connection of new nodes to the network or the disconnection of nodes from the network. Thereby, the first and second information can be updated in accordance with the connection of nodes to the network without any effects on information transmission between the other nodes, thus making it possible to realize a simple communication control device in which the increase or decrease in the number of nodes in the network does not affect the nodes of the network.

Still further, a communication control method of this invention comprises the first step of storing first information indicating all node identifiers used in the network to which own node is connected and second information indicating the node identifiers of all nodes directly or indirectly connected to each port of own port, and the second step of controlling communications with another node based on the first and second information and updating the first and/or second information in accordance with the connection of new nodes to the network and the disconnection of nodes from the network. Therefore, the first and second information can be updated in accordance with the connection of nodes to the network without any effects on information transmission between the other nodes, thus making it possible to realize a communication control method capable of simplifying the construction of a communication control device, in which the increase or decrease in the number of nodes in the network does not affect the nodes of the network.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a schematic diagram showing the construction of a network of this embodiment;

FIG. 2 is a block diagram showing the hardware construction regarding communications of nodes in this embodiment;

FIGS. 3A and 3B are schematic diagrams showing a specific construction of a node ID management memory;

FIGS. 4A to 4C are schematic diagrams showing a specific construction of a linked-node information management memory;

FIG. 5 to FIG. 12 are schematic diagrams explaining the node ID assignment processing in the network;

FIGS. 13 and 14 are flowcharts showing the ID assignment processing procedure;

FIG. 15 to FIG. 18 are schematic diagrams explaining the processing which is performed when new nodes are connected to the network;

FIG. 19 is a flowchart showing the connection processing procedure;

FIG. 20 to FIG. 24 are schematic diagrams explaining the processing which is performed when disconnection occurs in the network; and

FIG. 25 is a flowchart showing the disconnection processing procedure.

### DETAILED DESCRIPTION OF THE EMBODIMENT

Preferred embodiments of this invention will be described with reference to the accompanying drawings:

(1) Formation of Network 1 of this Embodiment

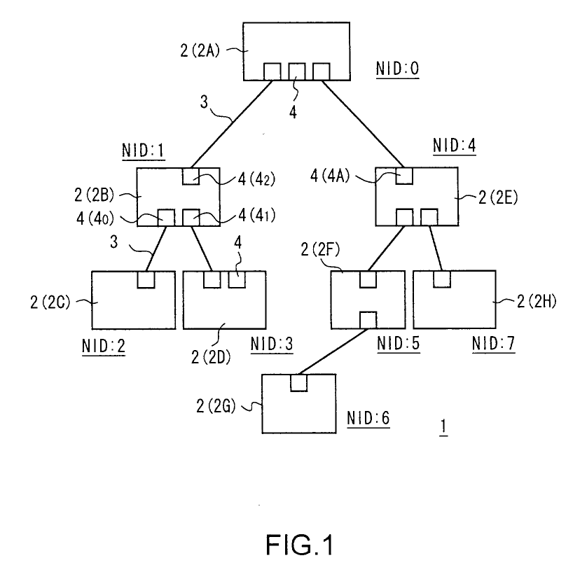

Referring to FIG. 1, reference numeral 1 shows a formation example of a spanning-tree network according to this embodiment as a whole. This network is composed by connecting plural nodes 2 (2A to 2H) which offer the same performance for communications and can perform double communications, with connecting cables 3 such as optical fibers or co-axial cables in a tree topology.

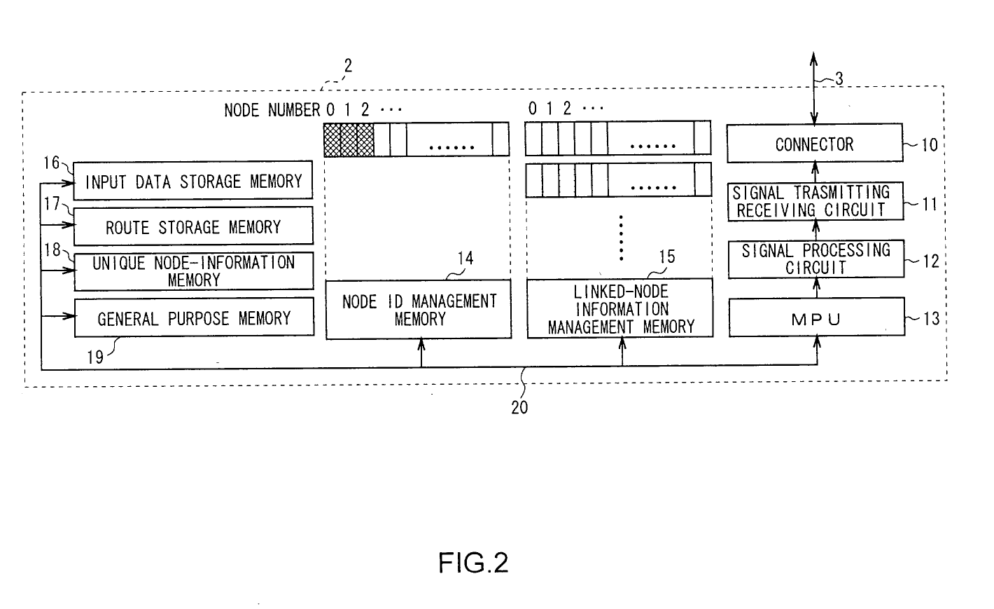

Each node 2 has hardware as shown in FIG. 2 for communications with another node 2, and a signal transmitting/receiving circuit 11 receives electric or optical signals transmitted from another node 2 through the connecting cable 3 via a connector 10 and then converts them into meaningful data.

Then, a signal processing circuit 12 performs necessary signal processing on this data and gives the resultant to a Micro Processing Unit (MPU) 13. The MPU 13 carries out necessary processing based on this data and various data stored in various internal memories which are described later.

On the other hand, the MPU 13 gives data to be transmitted to another node 2, to the signal transmitting/receiving circuit 11 via the signal processing circuit 12. The signal transmitting/receiving circuit 11 converts this data into a prescribed formatted electric or optical signal which is then outputted to the network 1 via the connector 10.

Note that, when the node 2 has plural ports 4 (FIG. 1), a set of the connector 10, signal transmitting/receiving circuit 11 and signal processing circuit 12 is connected to the MPU 13 for each port 4.

The internal memories of this node 2 are a node ID management memory 14, linked-node information management memory 15, input data storage memory 16, route storage memory 17, unique node-information memory 18 and general purpose memory 19.

This node ID management memory 14 is used as a memory for storing all node IDs used in the network to which the node 2 belongs. In this embodiment, a node (hereinafter, this referred to as a root node) 2 (2A) which controls the whole network 1 is assigned “0” as its node ID and the other nodes 2 (2B to 2H) are assigned positive numbers starting with “1”, and then the node ID management memory 14 stores one-bit data indicating whether each node ID (0, 1, 2, 3, . . . ) is used, by associating with the node ID.

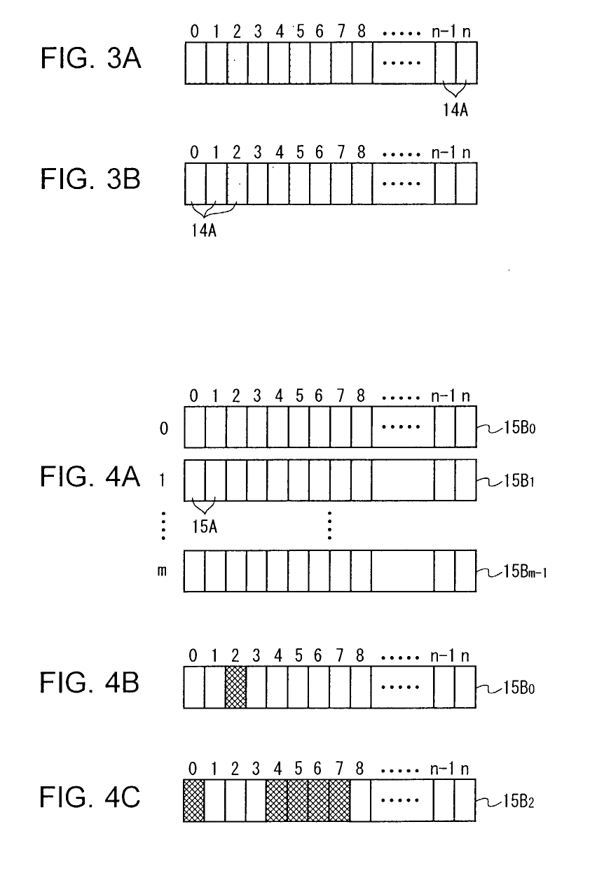

Specifically, the node ID management memory 14 has storage regions (hereinafter, referred to as flag storage regions) 14A each of which has capacity of one bit and which correspond to nodes IDs from “0” to the positive number “n” arbitrary set in accordance with the scale of the network 1, as shown in FIG. 3A.

In addition, in the case of the topology network 1 shown in FIG. 1, for example, a flag “1” indicating that a node ID is used is stored in each of the flag storage regions 14A corresponding to the node IDs “0” to “7” in the node ID management memory 14 of each node 2 (2A to 2H) as shown in FIG. 3A. If the node 2 (2D) having the node ID “3” is disconnected from the network 1 in such a situation, a flag “0” indicating that a node ID is not used is stored in the flag storage region 14A corresponding to the node ID “3” in the node ID management memory 14 as shown in FIG. 3B.

Therefore, the storage capacity of the node ID management memory 14 changes according to the scale of the network 1, which is useful for a network in a localized environment, for example, a home-used network. Note that, information about all node IDs used in own network, which is stored in the node ID management memory 14, is hereinafter referred to as node ID management information.

The linked-node information management memory 15 is used to store the node IDs of all nodes 2 linked to each port 4 of the node 2. And in this embodiment, one-bit data indicating whether a node 2 having a node ID is linked to each port 4 is stored in the linked-node information management memory 15 by associating with the node ID.

Specifically, the linked-node information management memory 15 is provided with linked-node information storage regions 15B₀-15Bₘ₋₁ (m indicates the number of ports of the node 2) for each port 4, each composed of one-bit storage regions (hereinafter, referred to as flag storage regions) corresponding to the node IDs from “0” to the positive number “n” arbitrarily set according to the scale of the network 1, as shown in FIG. 4A. As to the linked-node information storage regions 15B₀ to 15Bₘ, the flag storage region 15A corresponding to the node ID of each of the nodes 2 linked to each port 4 sores a flag “1” indicating that the node 2 having the node ID is linked.

For example, a port 4₀ having the port number “0” of the node 2B in FIG. 1 is linked to one node 2C assigned “2” as its node ID, so that the flag storage region 15A corresponding to the node ID “2” in the linked-node information storage region 15B₀ corresponding to the port 4₀ in the linked-node information management memory 15 of the node 2B stores “1”, as shown in FIG. 4B. Besides, nodes which are linked to the port 4₂ having the port number “2” of the node 2B are 5 nodes 2A, 2E to 2H given “0”, “4”-“7”, respectively, as their node IDs, so that “1” is stored in the flag storage regions 15A corresponding to the node IDs “0”, “4” to “7” in the linked-node information storage region 15B₂ corresponding to the port 4₂ in the linked-node information management memory 15, as shown in FIG. 4C.

When a new node 2 is connected to the network 1, the new node 2 requests for assignment of a node ID (hereinafter, referred to as a node-ID assignment request) to the root node 2 (2A). In this case, each node 2 through which the node-ID assignment request passed stores information indicating what port 4 received the node-ID assignment request, and when the root node 2 (2A) notifies the new node 2 of its node ID, the node 2 stores the node ID in its node-ID management memory 14 and also stores the node ID in the linked-node information management memory 15 by associating with the port number of the above port 4. Each node through which the node-ID assignment request did not pass stores the node ID in the node-ID management memory 14 and also stores the node ID in the linked-node information management memory 15 by associating with the port number stored in the route storage memory 17 which is described later, based on a broadcast signal which is transmitted from the root node 2 (2A) to each node 2 at a later time. Hereinafter, information about the node IDs of all nodes 2 linked to a port 4, which is stored in the linked-node information management memory 15, is referred to as linked-node information.

The input data storage memory 16 is a memory to store the total number of nodes linked to each port 4, and has a function for keeping this information for a while or for a long time because it is used for node-ID assignment processing as described later. In addition, the route storage memory 17 is a memory to store the port number of the port 4 which received various messages from the root node 2 (2A). Each of these input data storage memory 16 and route storage memory 17 has storage capacity of approximately several bits.

The unique node-information memory 18 is a memory for storing information unique to own node 2, for example, an ID unique to the node 2 in the world (hereinafter, referred to as UID) and a vender unique ID (hereinafter, referred to as vender ID).

The general purpose memory 19 is a memory for temporarily storing data in input or output of data or various processing, and is connected to the MPU 13 with the bus line 20.

The MPU 13 uses this general purpose memory 19 as a work memory to detect the topology of the network 1 to which own node is connected, based on various data stored in the node ID management memory 14, linked-node information management memory 15, input data storage memory 16, route storage memory 17 and so on, in order to control communications with another node based on the various data.

Note that, a non-volatile memory such as an Electrically Erasable and Programmable ROM (EEPROM), which data can be recorded in and read from and is not deleted even the power is turned OFF, is used as the internal memories of the node 2 (node ID management memory 14, linked-node information management memory 15, input data storage memory 16, route storage memory 17 and unique node-information memory 18).

(2) Node-ID Assignment Processing of this Embodiment

Next explanation will be made about the node-ID assignment processing to each node 2 in the network 1, using an example where the power of all nodes 2 is turned ON at the same time.

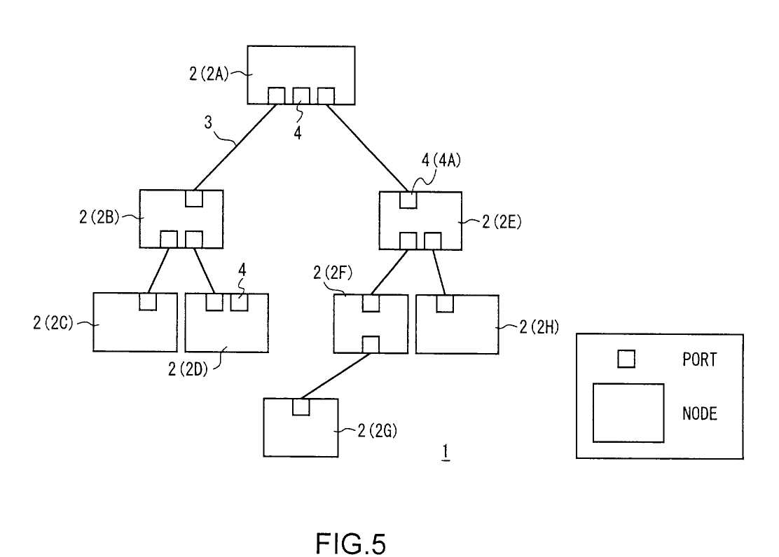

FIG. 5 shows an initial state in which the power of all nodes 2 is OFF in the network 1. When the power of all node 2 is turned ON at the same time in this initial state, each node 2 detects whether each port 4 is connected to another nodes 2, and thereby recognizes the ports 4 (hereinafter, referred to as active ports 4A) each having a connection with a node 2.

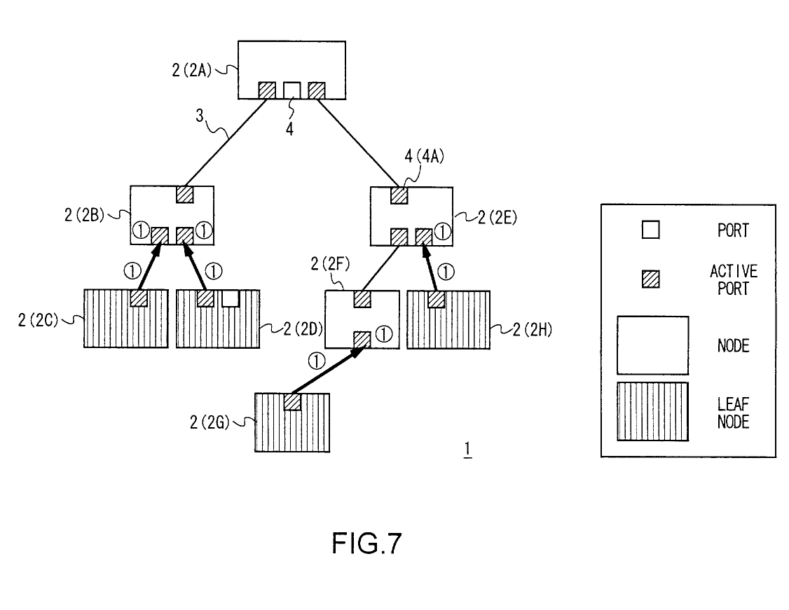

Then, as shown in FIG. 7, each of nodes 2 (2C, 2D, 2G, 2H) each having only one active port 4A recognizes own node to be a leaf node (node which connects to only one node), and then notifies the node 2 (2B, 2E, 2F) connected to the active port 4A that the number of nodes connected to own node (hereinafter, simply referred to as the number of connected nodes) is “1”. In the following explanation, the leaf node is referred to as the lowest node 2 of the network 1, a node having a connection order close to the leaf node as a lower node 2, and a node having a connection order farther to the leaf node as a higher node 2.

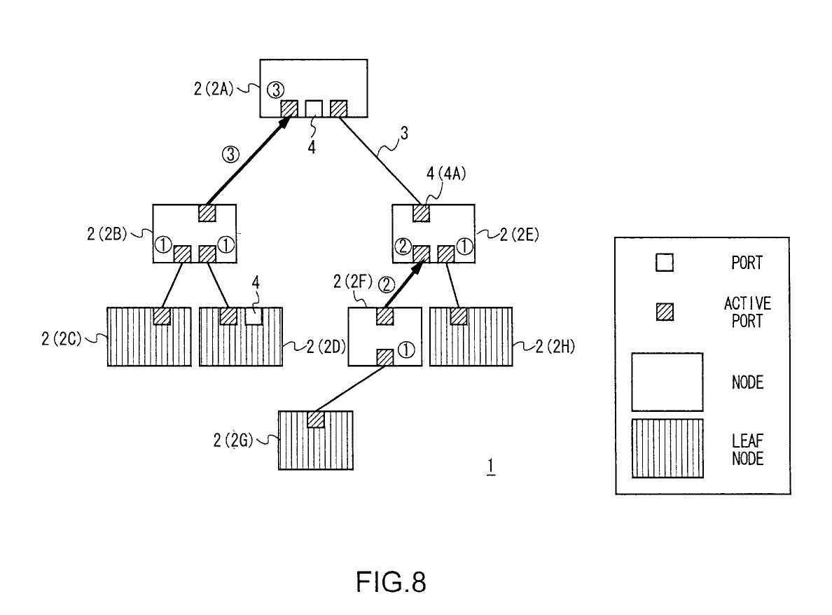

Next, each of the nodes 2 (2B, 2E, 2F) received the notification of the number of connected nodes from the corresponding leaf node 2 (2C, 2D, 2G, 2H) stores the given number of connected nodes in the input data storage memory 16 by associating with the port number of the port 4 which received the notification, and also detects how many active ports 4A which have not received such notification exist. In the case where the number of such active ports 4A is one, the node 2 (2B, 2E, 2F) notifies the node 2 (2A, 2E) connected to the active port 4A of a value obtained by adding the total of the numbers of connected nodes received by the other active ports 4A to “1” for own node, as the number of connected nodes, as shown in FIG. 8.

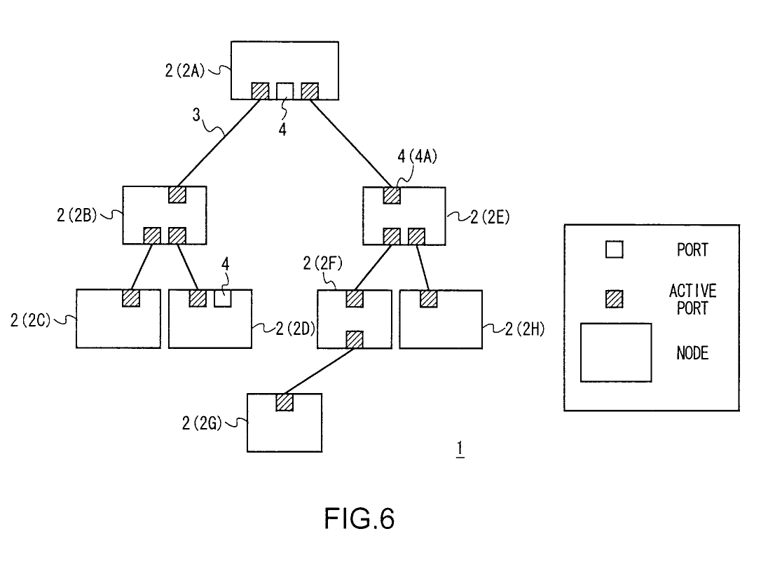

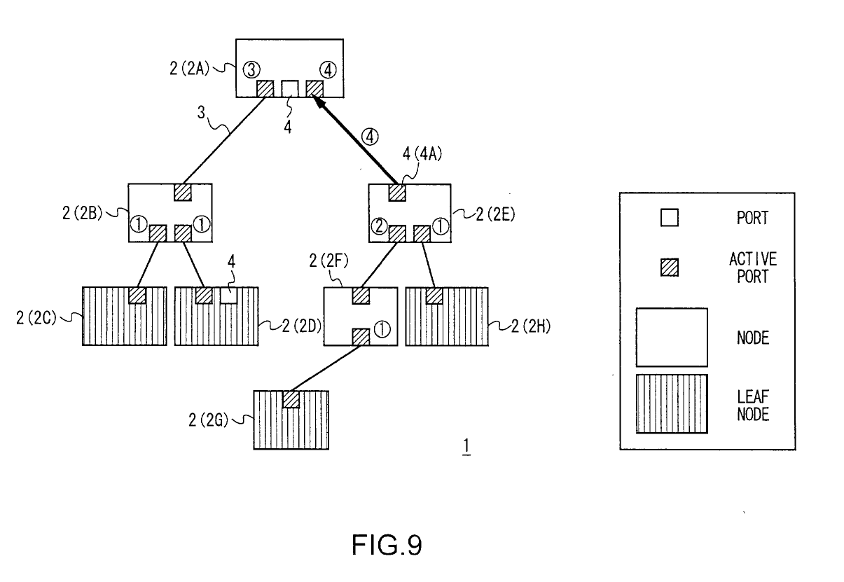

Similarly, as shown in FIG. 9, the node 2 (2E) which received such notification stores the given number of connected nodes in the input data storage memory 16 by associating with the port number of the port 4 which received the notification, and notifies the node 2 (2A) connected to the last one active port 4A which is not given such notification, of as the number of connected nodes a value obtained by adding the total of the numbers of connected nodes received by the other active ports 4A to “1” for own node. Note that, if there are higher nodes 2 than the node 2A, the nodes 2 carry out the same processing although FIG. 5-FIG. 9 do not show this case.

Finally, the node 2 (2A) which received the notification of the number of connected nodes via its all active ports 4A is detected, and this node 2 (2A) becomes a root node of this network 1.

When the root node is detected, the root node 2 (2A) assigns a node ID to the node 2 (2B, 2E) connected to each active port 4A based on the numbers of connected nodes received via its active ports 4A and transmits this node ID as assigned ID data to the node 2 (2B, 2E).

In actual, the root node 2 (2A) first assigns “0” to own node as own node ID and then assigns “1” as a node ID to the node 2 (2B) connected to the first active port 4A having the smallest port number and gives this as assigned ID data to the node 2 (2B).

With respect to the node 2 (2E) connected to the second active port 4A having the bigger port number next to the first active port 4A, the root node 2 (2A) assigns as the node ID of the node 2 (2E) a value obtained by adding the number of connected nodes received by the first active port 4A, stored in the input data storage memory 16, to “1”, and gives this as assigned ID data.

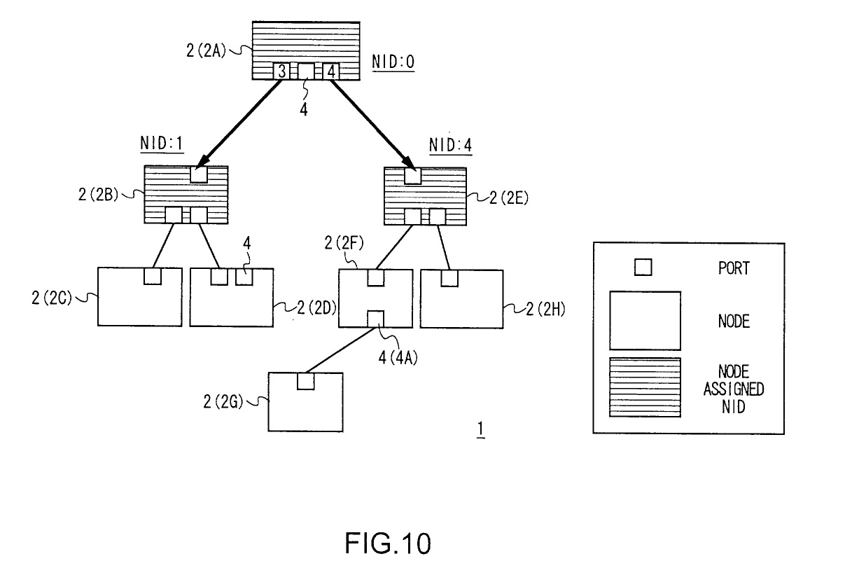

Note that, although FIG. 10 does not show the following case, if the root node 2 (2A) has a third active port 4A having the bigger port number next to the second active port 4A, the root node 2 (2A) assigns to the node 2 connected to the third active port 4A as the node ID of the node 2 a value obtained by adding the total of the numbers of connected nodes received by the first and second active ports 4A, stored in the input data storage memory 16, to “1” and further, if the root node 2 (2A) has a fourth active port 4A having a bigger port number next to the third active port 4A, the root node 2 (2A) assigns to the node 2 connected to the fourth active port 4A as the node ID of the node 2 a value obtained by adding the total of the numbers of connected nodes received by the first to third active ports 4A, stored in the input data storage memory 16, to “1” and gives this to the node 2 as the assigned ID data.

In this way, in the increasing order of the port numbers of the active ports 4A, the root node 2 (2A) assigns as the node ID of the node 2 (2B, 2E) connected to an active port 4A a value obtained by the total of the numbers of connected nodes received by the active ports having the smaller port numbers than the active port 4A and notifies the node 2 (2B, 2E) of this.

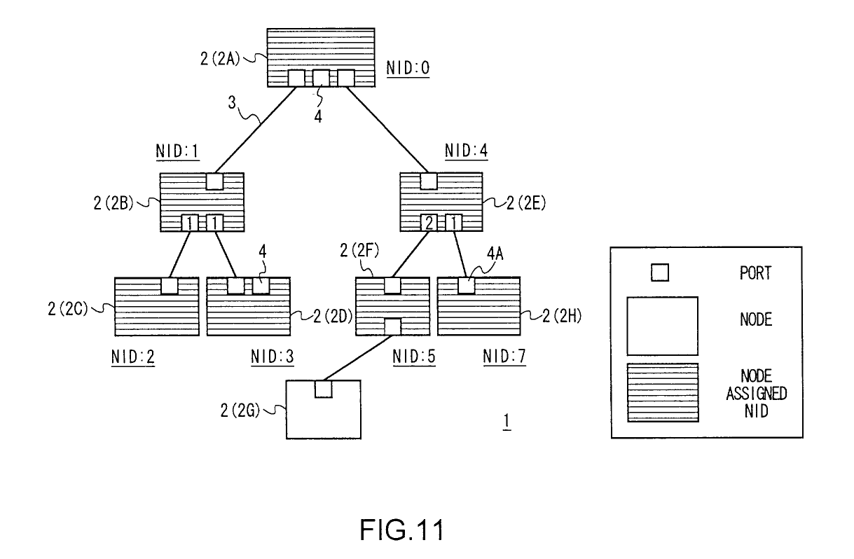

On the other hand, as shown in FIG. 11, each node 2 (2B, 2E) given the node ID as described above, assigns a node ID to the node 2 (2C, 2D, 2F, 2H) connected to each active port 4A of own node 2 based on the node ID of own node 2.

In actual, except the active port 4A connected to the root node 2 (2A) out of the active ports 4A of own node, the node 2 (2B, 2E) assigns a value obtained by adding the node ID of own node to “1” to the node 2 (2C, 2F) connected to the first active port 4A having the smallest port number, as the node ID of the node 2 (2C, 2F) and gives this to the node 2 (2C, 2F) as assigned ID data.

In addition, to the node 2 (2D, 2H) connected to the second active port 4A having the bigger port number next to the first active port 4A, except the active port 4A connected to the root node 2 (2A) out of the active ports 4A of the own node, the node 2 (2B, 2E) assigns as the node ID of the node 2 (2D, 2H) a value obtained by adding the total of the value of the node ID of own node and the number of connected nodes received by the first active port 4A as described above, to “1”, and gives this to the node 2 (2D, 2H) as assigned ID data.

Furthermore, although FIG. 11 does not show the following case, if the node 2 (2B, 2E) has a third active port 4A having a bigger port number next to the second active port 4A, except the active port 4A connected to the root node 2 (2A), the node 2 assigns to the node 2 connected to the third active port 4A, as the node ID of the node 2, a value obtained by adding the total of the value of the node ID of own node and the numbers of the connected nodes received by the first and second active ports 4A to “1” and further, if the node 2 (2B, 2E) has a fourth active port 4A having the bigger port number next to the third active port 4A, the node 2 (2B, 2E) assigns to the node 2 connected to the fourth active port 4A as the node ID of the node 2 a value obtained by adding the total of the value of the node ID of own node and the numbers of connected nodes received by the first to third active ports 4A, to “1”, and gives this to the node 2 as assigned ID data.

In this way, the node 2 (2B, 2E) assigns a value obtained by adding the total of the value of the node ID of own node and the numbers of connected nodes received by the active ports 4A having smaller port numbers than an active port 4A to “1”, as the node ID of the node 2 connected to the active port 4A and notifies the node 2 of this.

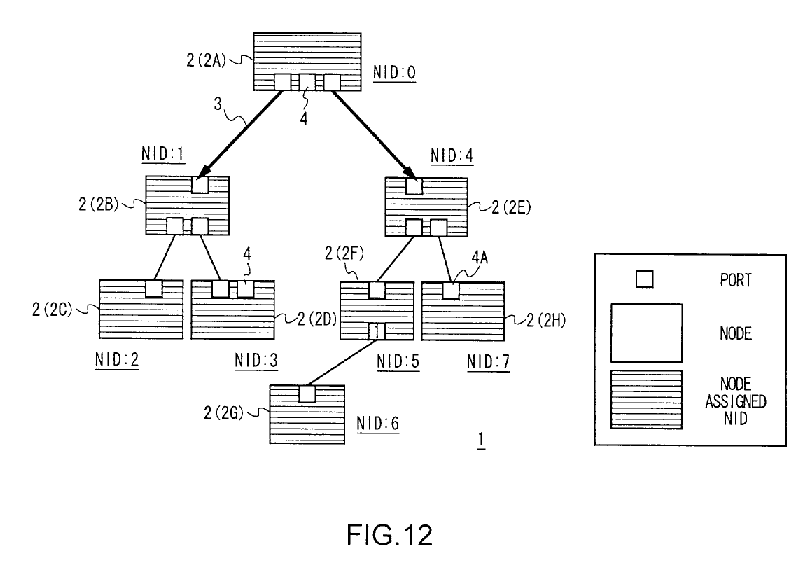

Then, all nodes 2 (2B, 2E, 2F), except the leaf nodes 2 (2C, 2D, 2G, 2H), perform the same processing, so that the node IDs are finally assigned to all nodes 2 (2B to 2H) as shown in FIG. 12.

In this connection, while the above node ID assignment processing is performed, the root node 2 (2A) recognizes the node IDs given to the nodes 2 linked to each port 4 based on the numbers of connected nodes received by the active ports 4A, stored in the input data storage memory 16, and stores a flag in the corresponding flag storage region 15A (FIG. 4A) of the linked-node information storage regions 15B₀-15Bₘ₋₁ (FIG. 4A) in the linked-node information management memory 15 based on the recognition result and on the other hand, recognizes all node IDs used in the network 1 and stores a flag in the corresponding flag storage region 14A (FIG. 3A) of the node ID management memory 14 based on the recognition result.

When the root node 2 (2A) is informed that the node ID assignment processing to all nodes 2 has been terminated as described above, via notification from the leaf nodes 2 (2C, 2D, 2G, 2H) for example, it transmits a broadcast signal to all nodes 2 (2B to 2H) to inform them of all node IDs used in this network 1 or the maximum node ID, based on the numbers of connected nodes received by the active ports 4A, stored in the input data storage memory 16 (FIG. 2).

Other than the root node 2 (2A), each node 2 (2B to 2H) which received such notification stores the port number of the port 4 which received this notification in the route storage memory 17, and recognizes all node IDs used in this network 1 from this notification, and stores a flag in the storage region 14A corresponding to each used node ID in the node ID management memory 14 based on the recognition result.

In addition, each of these nodes 2 (2B to 2H) recognizes the node IDs given the nodes 2 (2A to 2H) linked to each port 4, based on the all node IDs and the node IDs assigned to the lower nodes (2C, 2D, 2F to 2H) as described above, and stores a flag in the corresponding flag storage region 15A (FIG. 4A) of the linked-node information storage regions 15B₀ to 15Bₘ₋₁ (FIG. 4A) of the linked-node information management memory 15 based on the recognition result. In this way, each node 2 (2A-2H) produces the topology information on the network 1.

The next explanation is about the processing by the MPU 13 (FIG. 2) of each node 2 in such node ID assignment processing.

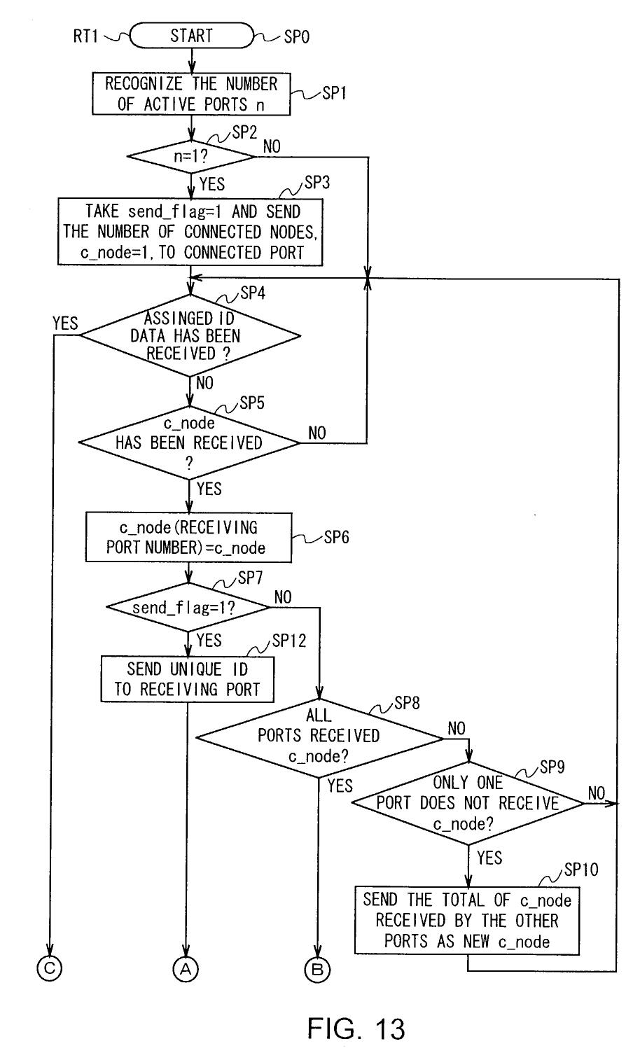

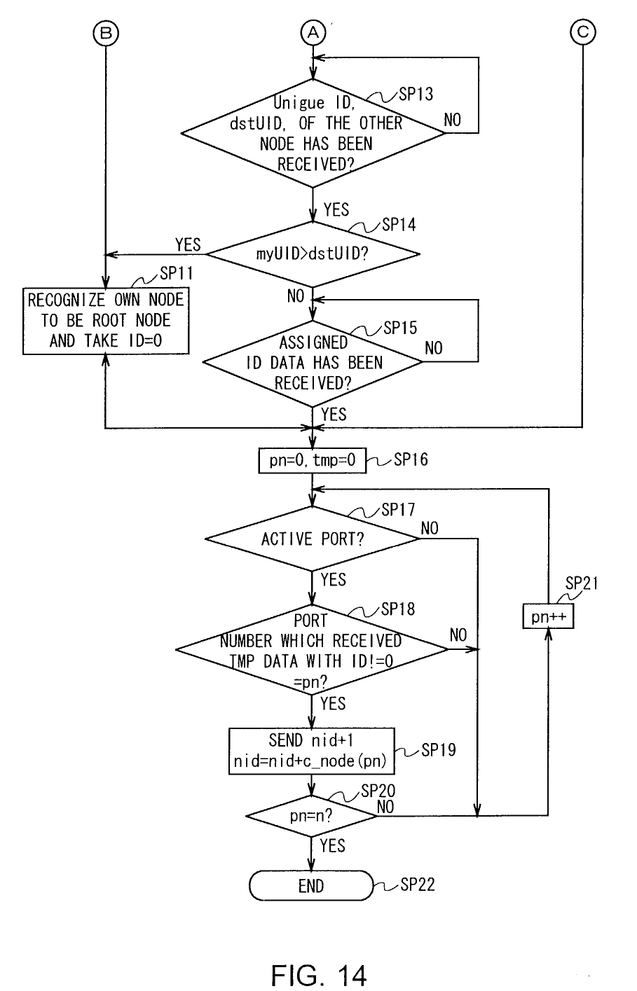

When the power is turned ON, the MPU 13 of each node 2 first starts an ID assignment processing procedure RT1 shown in FIGS. 13 and 14 at step SP0, and then detects at step SP1 whether each port 4 (FIG. 1) of own node is an active port 4A.

In actual, the detection result is obtained by outputting a Ping signal from each port 4 and thereby detecting whether there is a response to this signal. Thus, the number of active ports is detected.

Then, the MPU 13 moves to step SP2 to determine whether the number of active ports 4A obtained at step SP1 is one. When an affirmative result is obtained at step SP2, the MPU 13 recognizes that own node is a leaf node and moves to step SP3 to set to “1” an internal send flag indicating that data on the number of connected nodes (hereinafter, referred to as number-of-connected-node data) has been transmitted to the corresponding node 2 from the active port 4A and to send the number of connected nodes to own node as number-of-connected-node data (c_node) to the node 2 connected to the active port 4A. In this case, the MPU 13 has recognized that own node is a leaf node, so that it sends “1” as the number-of-connected-node data. After sending this number-of-connected-node data, the MPU 13 moves to step SP4.

If a negative result is obtained at step SP2, on the contrary, the MPU 13 recognizes that own node is not a leaf node and moves to step SP4, and then repeats steps SP4 and SP5 to wait for any active port 4A to receive assigned ID data or number-of-connected-node data from the corresponding node 2.

When the MPU 13 obtains an affirmative result at step SP5 by receiving the number-of-connected-node data via any active port 4A thereafter, it moves to step SP6 to store a value (number of connected nodes) based on this number-of-connected-node data in the input data storage memory 16 by associating with the port number of the active port 4A.

Then, at steps SP7, SP8, and SP9, the MPU 13 sequentially determines whether the internal send flag is “1”, whether its all active ports have received the number-of-connected-node data from the corresponding nodes 2, and whether the number of active ports 4A which have not received the number-of-connected-node data is only one.

When negative results are obtained at all steps SP7 to SP9, the MPU 13 returns to step SP4 to repeat a loop of steps SP4 to SP9 until an affirmative result is obtained at any step.

When an affirmative result is obtained at step SP9 thereafter, the MPU 13 moves to step SP10 to take a value obtained by adding the total of the numbers of connected nodes based on the number-of-connected-node data received by the other active ports (that is, active ports which have received the number-of-connected-node data) 4A, other than the active port which has not received the number-of-connected-node data, to “1”, as the number of connected nodes, and to transmit this as number-of-connected node data to the node 2 connected to the active port 4A which has not received the number-of-connected node data, via the active port 4A. Then, the MPU 13 returns to step SP4.

When an affirmative result is obtained at step SP8, the MPU 13 moves to step SP11 to recognize own node to be a root node, and then performs the node ID assignment processing to the nodes 2 connected to own node 2 as described later after step SP16.

Note that, there is such a case that number-of-connected-node data is received at step SP5 after the number-of-connected-node data is transmitted via the last one active port 4A to the node 2 at step SP10.

This case occurs in such a situation where there are two highest nodes 2 located in parallel in the spanning tree shown in FIG. 1 and these two nodes 2 mutually transmit the number-of-connected-node data almost at the same time. In this case, the MPU 13 of each node 2 executes step SP7 and steps SP12 to SP14, so that either node 2 becomes a root node.

Specifically, when the MPU 13 of each of two nodes 2 receives the number-of-connected-node data at step SP5 after transmitting the number-of-connected-node data from the last one active port 4A to the other node 2, it moves to step SP7 through step SP6 to determine whether a send flag corresponding to the active port 4A is “1”.

At this time, an affirmative result is obtained at step SP7 because the MPU 13 has sent the number-of-connected-node via the active port 4A as described above, and it moves to step SP12 to read the node ID unique to the own node 2 (hereinafter, referred to as UID), stored in the unique node-information memory 18 (FIG. 2), and then to transmit this to the other node 2 via the active port 4A.

Then, the MPU 13 moves to step SP13 to wait for the other node 2 to transmit its UID, and when receiving the UID thereafter, it moves to step SP14 to determine whether the UID of own node is bigger than the UID of the other node.

When an affirmative result is obtained at step SP14, the MPU 13 moves to step SP11 to recognize own node to be a root node and moves to step SP16. When a negative result is obtained at step SP14, on the contrary, the MPU 13 moves to step SP15 and waits for the assigned node ID data for assignment of node ID.

On the other hand, the MPU 13 which recognized own node to be a root node at step SP11 because of an affirmative result at step SP8 or step SP14, performs prescribed initial processing for node ID assignment processing to the nodes 2 directly connected to the active ports 4A of own node at following step SP16.

In actual, as the initial processing, the MPU 13 sets the port number of a port 4 which is subjected to processing, to “0” and sets the number of connected nodes given via the port 4 from the corresponding connected node 2, to “0”.

Sequentially, the MPU 13 moves to step SP17 to determine based on information stored in the linked-node information management memory 15 (FIG. 2) whether this port (port having the port number “0”, in this case) is an active port 4A.

When a negative result is obtained at step SP17, the MPU 13 moves to step SP21 to increase the port number of a port 4 which is subjected to processing by “1” and returns to step SP16, and then repeats a loop of steps SP17-SP21-SP17 until an affirmative result is obtained at step SP17.

When an affirmative result is obtained at step SP17 thereafter, the MPU 13 moves to step SP18 to determine based on information stored in the input data storage memory 16 (FIG. 2) whether the port 4 has received the number-of-connected-node data.

A negative result at step SP18 means that the node 2 connected to the port 4 is a node closer to the root node in view of the connection priority than own node in the network 1, and in this case, the MPU 13 moves to step SP21 and repeats a loop of steps SP21-SP17-SP18-SP21. It should be noted that when the node 2 is a root node, a negative result is not obtained at step SP18 with sure.

An affirmative result at step SP18 means that the node 2 connected to the port 4 is a lower node 2 farther from the root node in view of the connection priority than own node in the network 1. In this case, the MPU 13 moves to step SP19 to transmit a value obtained by adding the node ID assigned to own node or the node ID assigned to own node by the higher node 2 (hereinafter, referred to as assigned node ID), to “one” for own node, via the port 4 to the node connected to this port 4 as assigned node ID data. Note that, the assigned node ID is “0” when own node is a root node.

In addition, the MPU 13 stores as a newly assigned node ID a value obtained by adding the value based on the assigned node ID data to the value based on the number-of-connected-node data given from the port 4, stored in the input data storage memory 16.

Further, at following step SP20, the MPU 13 determines whether the port number is the last port number of own node, and when a negative result is obtained, it moves to step SP21 and repeats steps SP17 to SP21 until an affirmative result is obtained at step SP20. When an affirmative result is obtained at step SP20 thereafter, the MPU 13 moves to step SP22 to terminate the ID assignment processing procedure RT1.

With respect to the MPU 13 of the node 2 which has received the assigned node ID data from the root node, an affirmative result is obtained at step SP4 or step SP15 and then the MPU 13 moves to step SP16. Then, the MPU 13 of the node 2 performs the processing of steps SP16 to SP22 as in the above case, thus sequentially assigning node IDs to the nodes 2 connected to the active ports 4A of own node.

Besides, each of the lower nodes 2 than this node 2 sequentially assigns node IDs to the nodes 2 connected to the active ports 4A of own node in the same way. As a result, the node IDs are assigned to all nodes connected to the network 1.

In this network system 1, a node ID is assigned to each node 2 in this way when the power of all nodes 2 is turned ON.

In a case where the power of some nodes 2 out of the nodes 2 composing the network 1 is turned ON at the same time, the same node ID assignment processing is performed in each of partial networks each composed of two or more nodes 2 of which the power has been turned ON in the network 1. Thereby, in the partial networks, a node ID is assigned to each node 2.

(3) Processing of Case Where New Nodes are Connected

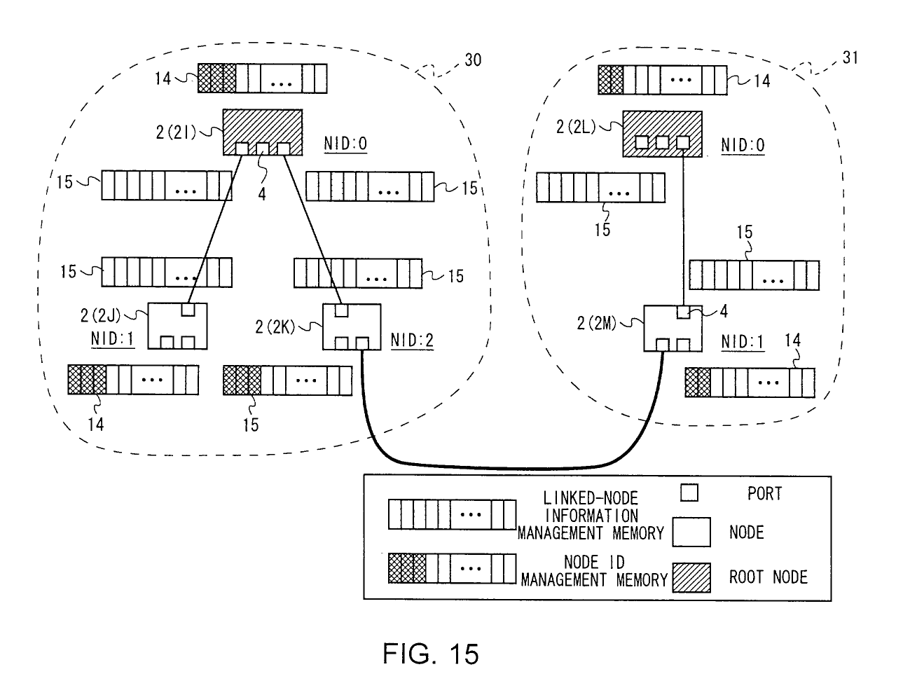

Next explanation will be made about processing of a case where new nodes 2 are connected to the network 1, using an example as shown in FIG. 15 in which a first network 30 composed of plural nodes 2 (2I to 2K) and a second network 31 composed of plural nodes (2L, 2M) are connected to each other.

In this case, while each node 2 does not communicate with any node 2, it is designated to output a prescribed idling signal from each port 4 and to thereby detect that a new node 2 has just connected to own node.

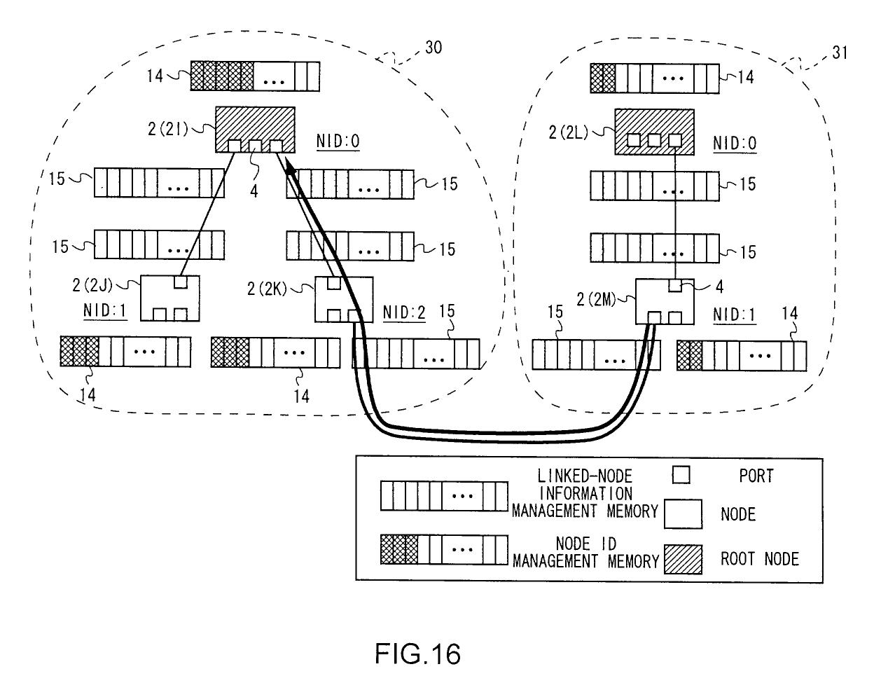

Then, in a case where an arbitrary node 2 (2K) in the first network 30 and an arbitrary node 2 (2M) in the second network 31 are connected to each other as shown in FIG. 15, the nodes 2 (2K, 2M), which are connecting ends, mutually transmit the UIDs of own nodes when detecting the connection. Then, as shown in FIG. 16, the network 30 including the node 2 (2K) having the bigger UID becomes a parent network and the network 31 including the node 2 (2M) having the smaller UID becomes a child network, and the node 2 (2M) which is the connecting end on the child network side (second network 31) requests the root node 2 (2I) of the parent network (first network 30) for the registration of all nodes 2 (2M, 2L) of the child network (second network 31) via the node 2 (2K) which is the connecting end on the parent network side (first network 30).

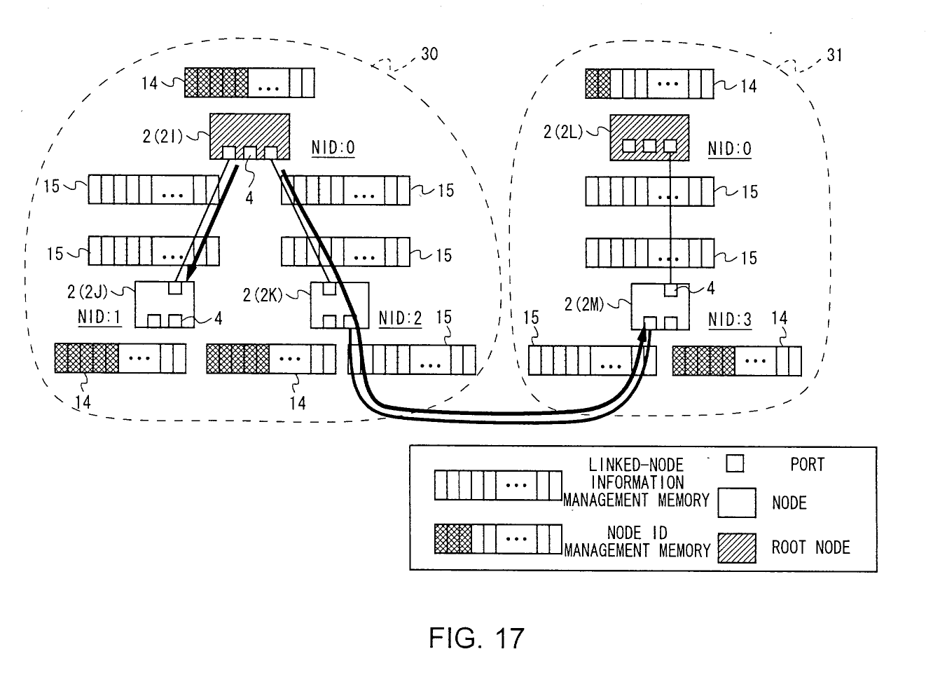

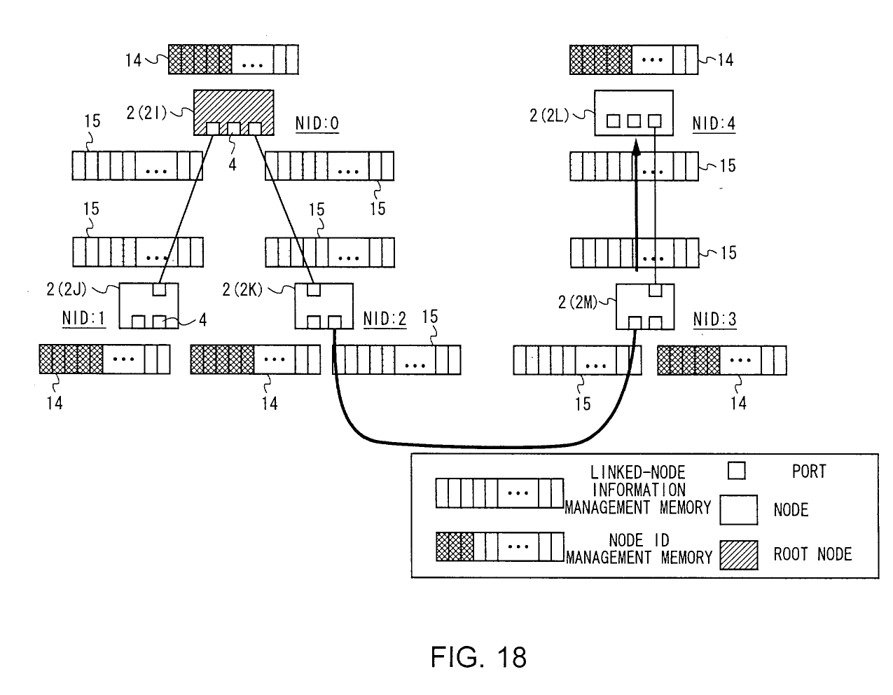

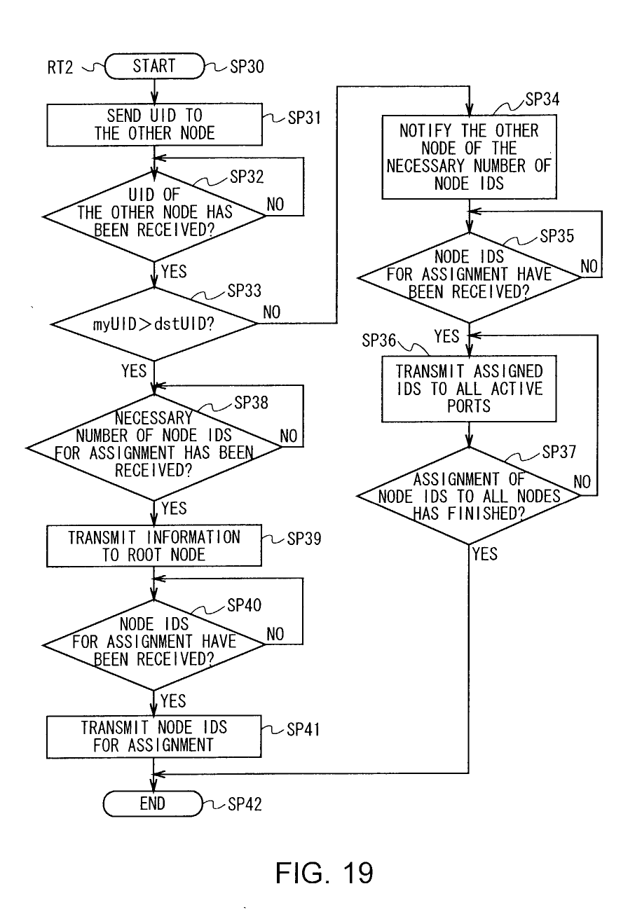

When the root node 2 (2I) of the parent network (first network 30) receives the request for registration, it prepares the requested number of node IDs, which have not been used, for assignment in an increasing order of bits, considering the node IDs of the nodes 2 (2I-2K) of the parent network (first network 30) stored in the node ID management memory 14. Then, as shown in FIG. 17, the root node 2 (2I) transmits these node IDs to the node 2 (2M) which is the connecting end on the child network side (second network 31), via the node 2 (2K) which is the connecting end on the parent network side (first network 30).

In addition, the root node 2 (2I) of the parent network (first network 30) notifies the other nodes 2 (2J, 2K) of the parent network (first network 30) that these node IDs have been assigned, so as to make each node 2 (2J, 2K) update the linked-node information stored in the linked-node information management memory 15 and the node ID management information stored in the node ID management memory 14.

On the other hand, when the node 2 (2M) which is the connecting end on the child network side (second network 31) receives the node IDs for assignment, it assigns them to the nodes 2 (2M, 2L) of the child network (second network 31) including own node, as shown in FIG. 18.

As described above, in the network 1, when these two networks 30, 31 are connected, necessary node IDs can be assigned, and similarly, even when one node 2 is connected to the network 30, 31, a node ID can be assigned to the node 2.

Now, explanation is about processing by the MPU 13 (FIG. 2) of each node 2 which is a connecting end when two networks 30, 31 are connected or when one node 2 is connected to the network 30, 31.

In this case, when the MPU 13 of each of two nodes 2 (2K, 2M) connected detects the connection based on an idling signal from the other node 2, it starts a connection processing procedure RT2 shown in FIG. 19 at step SP30, and transmits the UID of own node to the other node 2 (2M, 2K) at next step 31.

Then, the MPU 13 waits for the UID of the other node 2 (2M; 2K) to be transmitted from the other node 2 (2M, 2K) at step SP32, and when an affirmative result is obtained at step 32 by reception of the UID, the MPU 13 moves to step SP33 to determine whether the UID of own node is bigger than the UID of the other node 2 (2M, 2K).

When a negative result is obtained at step SP33, the MPU 13 moves to step SP34 to request the other node 2 (2M, 2K) for registration and notify it of the necessary number of node IDs for assignment (the same number as the number of nodes in the own network 30, 31). Then, the MPU 13 moves to step SP35 to wait for the necessary number of node IDs to be transmitted from the other node 2 (2M, 2K) for assignment.

When the MPU 13 receives the necessary number of node IDs for assignment from the other node 2 (2M, 2K) and thereby an affirmative result is obtained at step SP35, it moves to step SP36 to assign the node IDs to the nodes 2 (2I, 2J, 2L) including own network, of the own network 31, 30. At step SP37, the MPU 13 confirms that the node IDs have been assigned to all nodes 2 (2I, 2J, 2L) of own network 31, 30, and then it moves to step SP42 to terminate this connection processing procedure RT2.

When an affirmative result is obtained at step SP33, the MPU 33 moves to step SP38 to wait for the necessary number of node IDs for assignment to be transmitted from the other node 2 (2M, 2K), and when an affirmative result is obtained at step SP38 by the reception of the necessary number of node IDs for assignment thereafter, the MPU 31 moves to step SP39 to transmit the necessary number of the node IDs to the root node 2 (2I) of the own network 30, 31.

Then, the MPU 13 moves to step SP40 to wait for the necessary number of node IDs for assignment to be transmitted from the root node 2 (2I), and then when it receives the necessary number of node IDs for assignment, the MPU 13 moves to step SP41 to transfer them to the other node 2 (2M, 2K) and moves to step SP42 to terminate the connection processing procedure RT2.

(4) Processing of Case Where Network Connection is Disconnected

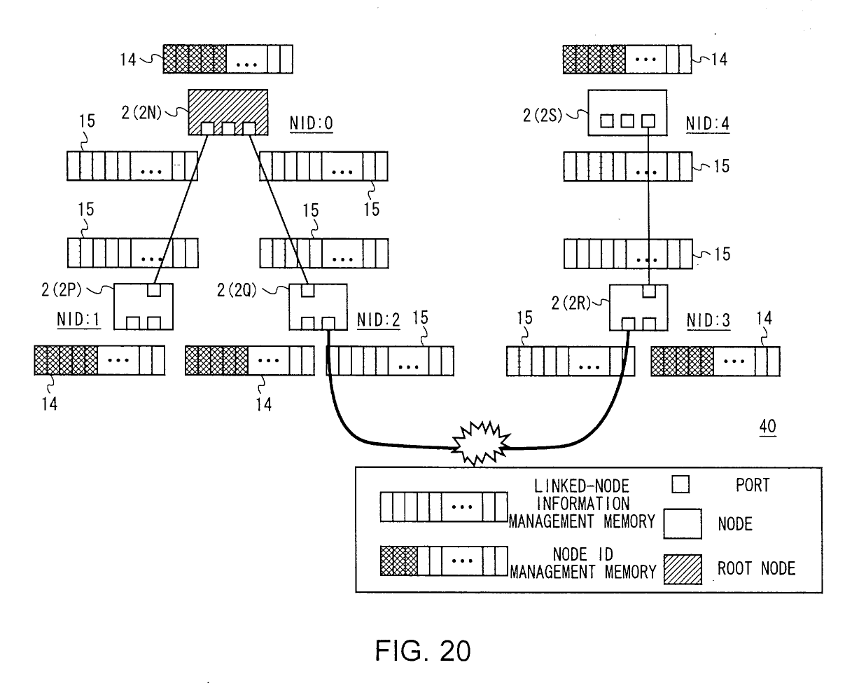

Next explanation is about processing of a case where a physical connection between nodes 2 (2Q, 2R) is disconnected in a network 40 of the present invention as shown in FIG. 20.

In the network 40 of this invention, while each node 2 does not communicate with any node 2, it outputs a prescribed idling signal from each port 4 as described above. Therefore, when a physical connection between arbitrary nodes 2 is disconnected, the disconnected nodes 2 (2Q, 2R) can recognize this disconnection.

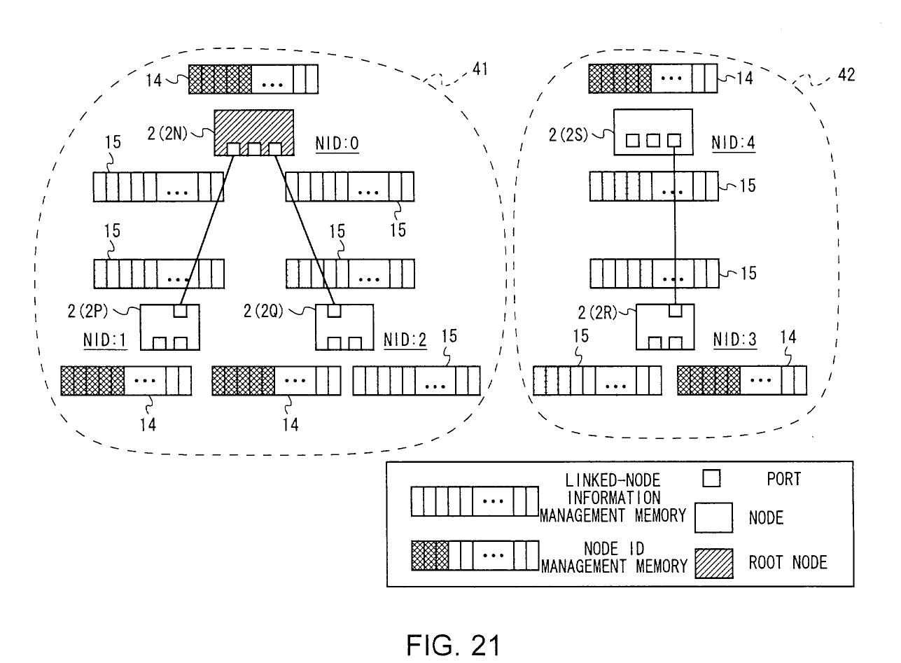

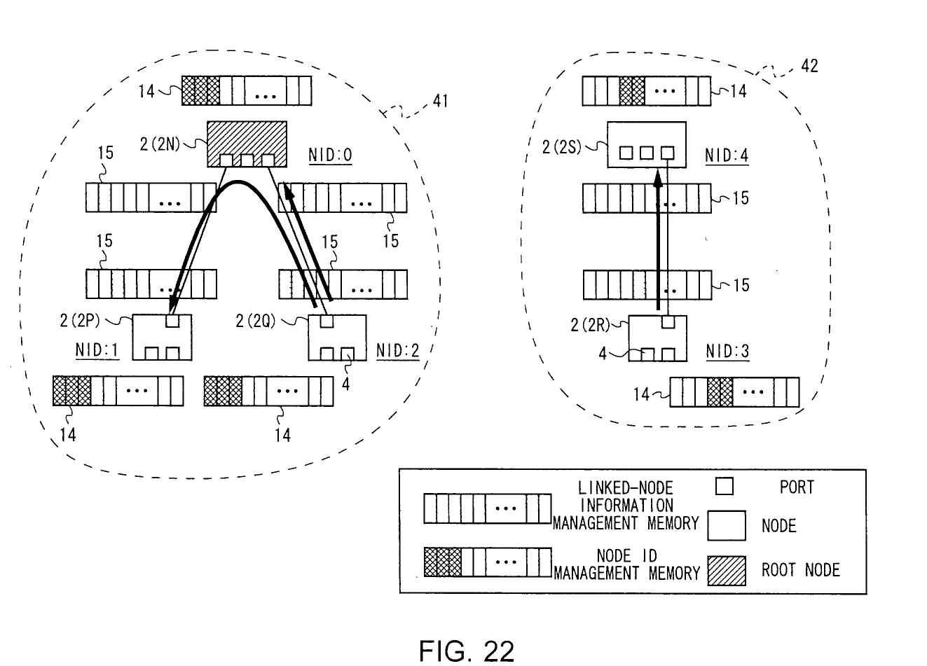

When these disconnected nodes 2 (2Q, 2R) recognize the disconnection as shown in FIG. 21, they recognize based on information stored in the linked-node information management memory 15 which node 2 is disconnected from the network 40, and then delete information about the nodes 2, which have been separated from the network 40, from the node ID management memory 14 and linked-node information management memory 15 based on the recognition result.

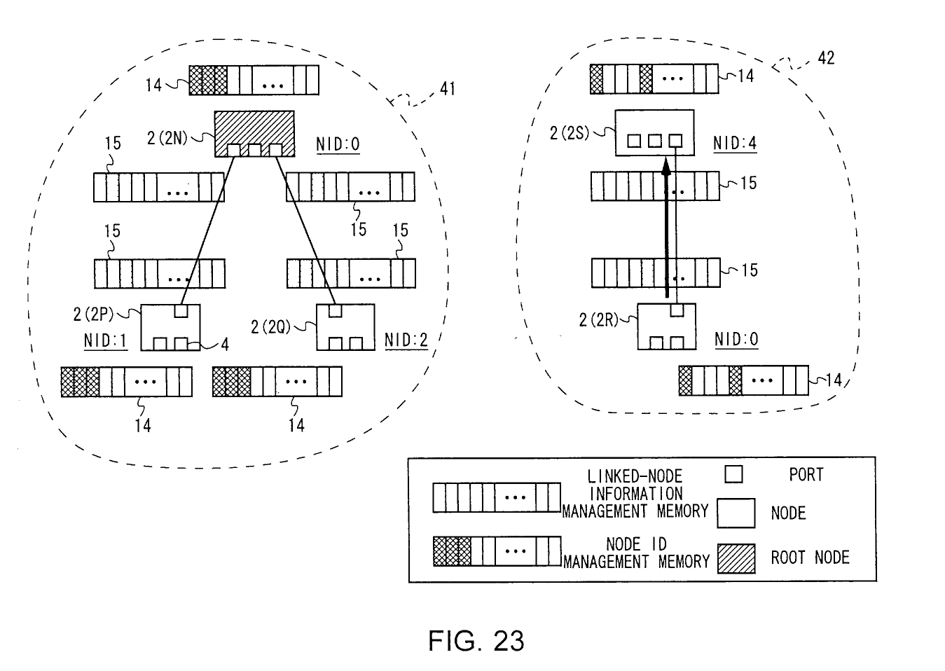

In addition, each disconnected node 2 (2Q, 2R) determines from the recognition result whether the root node 2 (2N) in the original network 40 exists in the current own network 41, 42, and when yes, it notifies the other nodes 2 (2N, 2P) including the root node 2 (2N) in the own network 41 of this disconnection by transmitting a broadcast signal, as shown in FIG. 22.

As a result, each node 2 (2N, 2P), which received this notification, deletes information about the nodes 2 (2R, 2S), which have been separated from the original network 40, from the node ID management memory 14 and linked-node information management memory 15, based on the notification. Thereby, this network 41 becomes one independent network.

When the disconnected node 2 (2Q, 2R) detects that the root node 2 (2N) does not exist in the own network 42 as shown in FIG. 23, on the contrary, it becomes a root node of own network 42 and sets the node ID of own node to “0” indicating the node ID of a root node, and notifies the other nodes 2 (2S) of own network 42 of this disconnection by transmitting a broadcast signal.

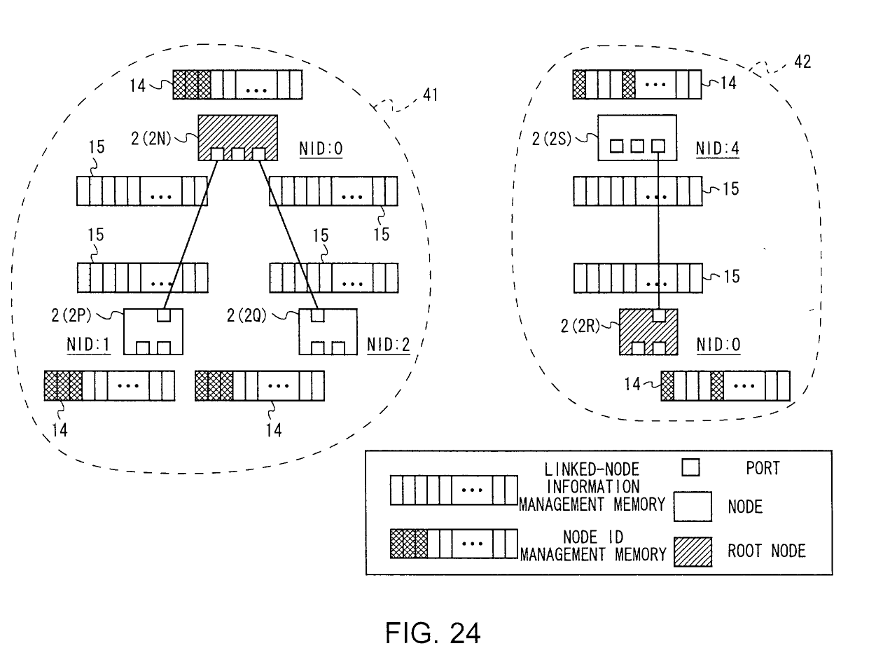

Each node 2 (2S) which has received this notification deletes information about the nodes 2 (2N to 2Q), which have been separated from the network 42, from the node ID management memory 14 and linked-node information management memory 15 based on this notification, and updates the information stored in the node ID management memory 14 and linked-node information management memory 15 for making the disconnected node 2 (2R) become a root node. Thus, this network 42 becomes one independent network as shown in FIG. 24.

As described above, in the network 40, even a physical connection between nodes is disconnected, each of the separated networks 41 and 42 can deal with the disconnection without any problems, and reconstruct its topology as an independent network.

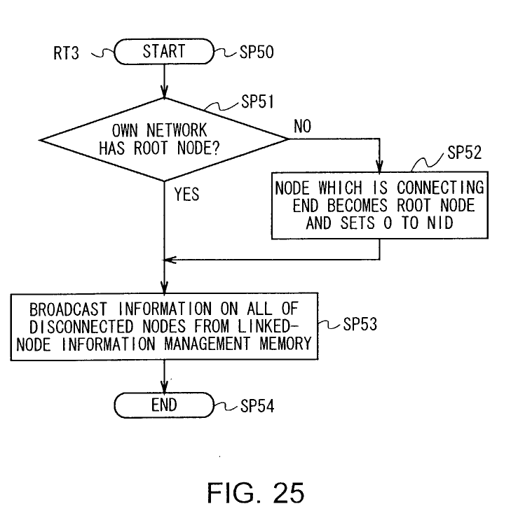

Note that the processing by the MPU 13 of each of the disconnected nodes 2 (2Q, 2R) at the time of such disconnection is performed in accordance with the disconnection processing procedure RT3 shown in FIG. 25.

That is, when the MPU 13 of each of the disconnected nodes 2 (2Q, 2R) detects a physical disconnection from the other node 2 (2R, 2Q) based on the idling signal from the other node 2 (2R, 2Q), it starts the disconnection processing procedure RT3 at step SP50, and at step SP51, it determines based on the information stored in the linked-node information management memory 15 and the route storage memory 17 whether the root node 2 (2N) exists in the network 41, 42 to which own node belongs.

When an affirmative result is obtained at step SP51, the MPU 31 moves to step SP53 to detect all nodes 2 (2R, 2S or 2N to 2Q) separated from the network 41, 42 to which own node belongs due to the disconnection, based on the information stored in the linked-node information management memory 15, and notifies all nodes 2 (2N to 2Q or 2R, 2S) of own network 41, 42 of the detection result by transmitting a broadcast signal. Then, the MPU 31 moves to step SP54 to terminate the disconnection processing procedure RT3.

When a negative result is obtained at step SP51, the MPU 13 moves to step SP52 to newly assign “0” to the node ID of own node in order to become the root node of a new network which has been separated from the original network.

Then, the MPU 13 moves to step SP53 to notify all nodes 2 (2S) of own network 42 that the node ID of own node is “0” by transmitting a broadcast signal, and moves to step SP54 to terminate this disconnection processing procedure RT3.

(5) Operation and Effects of this Invention

According to the above configuration, in the network 1 of this embodiment, each node 2 stores all node IDs used in the network 1, in the node ID management memory 14, and stores the node IDs of the nodes 2 directly or indirectly connected to each port 4, in the linked-node management memory 15, so as to control communications with another node 2 based on the node ID management information stored in the node ID management memory 14 and the linked-node information stored in the linked-node information management memory 15.

Then, when new nodes 2 are connected to the network 30 as shown in FIG. 15, for example, the root node 2 gives each of the new nodes 2 a node ID and notifies the other nodes 2 of this information to make the other node 2 update the node ID management information stored in the node ID management memory 14 and/or the linked-node information stored in the linked-node information management memory 15. When a node 2 or a part of the network 40 is disconnected from the network 40 as shown in FIG. 20, on the other hand, each of the disconnected nodes 2 of the network 40 notifies the other nodes 2 of this information, in order to make the other nodes 2 update the node ID management information stored in the node ID management memory 14 and/or the linked-node information stored in the linked-node information management memory 15.

In this way, the network 1 of this embodiment is capable of addressing without any effects of the connection or disconnection of the nodes 2 on information transmission between other nodes 2, and in addition, a special unit is not necessary for addressing, which can simplify the scale of the system.

In addition, in this case, the node IDs which are used in the network 1 are stored in the node ID management memory 14 as the presence of the flags in the flag storage regions 14A provided in correspondence with the node IDs (0, 1, 2, . . . ) previously set usable in the network 1, and similarly, the node IDs of all nodes 2 which are directly or indirectly connected to each port 4 of own node are stored in the linked-node management memory 15 as the presence of the flags in the flag storage regions 15A provided in correspondence with the node IDs previously set usable in the network 1. Therefore, the capacity of the memory required for addressing can be increasingly decreased, which can simplify the system and cut its cost down.

According to the above configuration, each node 2 stores all node IDs used in the network 1, in the node ID management memory 14 and stores the node IDs of all nodes directly or indirectly connected to each port of own node in the linked-node information management memory 15, and controls communications with another node 2 based on the node ID management information stored in the node ID management memory 14 and the linked-node information stored in the linked-node information management memory 15. When new nodes 2 are connected to the network 30, the root node 2 gives each of the new nodes 2 a node ID and notifies the other nodes 2 of this information to make the other nodes 2 update the node ID management information stored in the node ID management memory 14 and/or the linked-node information stored in the linked-node information management memory 15. When a node 2 or a part of the network 40 is disconnected from the network 40, on the contrary, the node 2 which is the disconnected end of the network 40 notifies the other nodes 2 of this information to make the other nodes 2 update the node ID management information stored in the node ID management memory 14 and/or the linked-node information stored in the linked-node information management memory 15. Thereby, it is possible to perform addressing without any effects of the connection or disconnection of nodes on information transmission between other nodes 2, and a special unit is not necessary for addressing, which simplify the scale of the system. Thus, such a simple network can be realized that the increase or decrease in the number of nodes in the network does not affect the nodes of the network.

(6) Other Embodiments

Note that, the above embodiment has described a case where the communication control device of this invention is constructed as shown in FIG. 2. This invention, however, is not limited thereto and various constructions can be applied.

Further, the above embodiment has described a case where integral numbers staring with “0” are applied to node identifiers. This invention, however, is not limited to this and other kinds of identifiers can be applied.

Still further, the above embodiment has described a case where in each node 2, the node ID management memory 14 as a first storage means for storing first information (node management information) indicating all node IDs used in the network 1, 30, 31, 40 stores the node IDs which are used in the network 1, 30, 31, 40 as the presence of the one-bit flags of the flag storage regions 14A provided in correspondence with the node IDs previously set usable in the networks 1, 30, 31, 40. This invention, however, is not limited to this and other various kinds of methods can be widely applied as a node ID storage method of the node management memory 14. For example, data of more than 2 bits can be stored in each flag storage region 14A.

Still further, the aforementioned embodiment has described a case where in each node 2, the linked-node information management memory 15 as a second storage means for storing second information (linked-node information) indicating the node IDs of all nodes which are directly or indirectly connected to each port 4 stores the above node IDs as the presence of the flags of the flag storage regions 15A provided in correspondence with the node IDs previously set usable in the network 1, 30, 31, 40. The present invention, however, is not limited to this and various kinds of methods can be widely applied as a node ID storage method of the linked-node information management memory 15. For example, data of more than 2 bits can be stored in each flag storage region 15A.

Still further, the above embodiment has described a case where, initially, a value obtained by adding the total number of lower nodes connected to own node to one is given as the number of connected nodes to the higher node, in an order from a leaf node which is the lowest node 2 (2C, 2D, 2G, 2H), in the network 1 and thereby a root node (node 2 (2A)) is determined, and after the determination of the root node (node 2 (2A)), the node IDs are sequentially assigned to the lower nodes 2 directly connected to own node based on the number of connected nodes given from the lower nodes 2 in an order from root node (node 2 (2A)). This invention, however, is not limited to this and other various kinds of methods can be widely applied as the root node determination method and the node ID assignment method to each node 2.

Still further, the aforementioned embodiment has described a case where, when the nodes 2 are disconnected from the network 40 (FIG. 20), the node 2 which is the disconnected end of the network 40 including the root node is applied as a node 2 for notifying the other nodes 2 of the disconnection. This invention, however, is not limited to this and the root node which received such notification from the node 2 which is the disconnected end can give this notification to the other nodes 2.

While there has been described in connection with the preferred embodiments of the invention, it will be obvious to those skilled in the art that various changes and modifications may be aimed, therefore, to cover in the appended claims all such changes and modifications as fall within the true spirit and scope of the invention.

What is claimed is:

1. A network system so constructed that plural nodes each given a unique node identifier compose a network without a logical loop, wherein:
each of said nodes comprises:
first storage means for storing first information indicating all of said node identifiers which are used in said network; and
second storage means for storing second information indicating said node identifiers of all of said nodes directly or indirectly connected to each port, and
when new nodes are connected to said network, a first node previously selected out of said nodes connected to the network gives said node identifier to each of the new nodes and notifies the other nodes of this information to make the other nodes update said first and/or second information, and when said nodes are disconnected from said network, a second node remaining in the network notifies the other nodes of this information to make the other node update said first and/or second information.

2. The network system according to claim 1, wherein
said first storage means stores said node identifiers which are used in said network as the presence of flags in storage regions provided in correspondence with said node identifiers previously set usable in the network.

3. The network system according to claim 1, wherein
said second storage means stores said node identifiers of all of said nodes which are directly or indirectly connected to each of said each port of own node as the presence of flags in storage regions provided in correspondence with said node identifiers previously set usable in the network.

4. The network system according to claim 1, wherein
at first, said first node is a root node determined in such a manner that a value obtained by adding the number of lower nodes connected to own node to one is given to the higher node as the number of connected nods in an order from the lowest node of said network.

5. The network system according to claim 4, wherein
after determination of said root node, said node identifiers are sequentially assigned to lower said nodes directly connected to own node based on said number of connected nodes given from the lower nodes, in an order from the root node.

6. The network system according to claim 1, wherein
said second node is said node which is a disconnected end on said network side having said first node.

7. The network system according to claim 1, wherein
said node which was disconnected from said network and is a disconnected end on a new network side without said first node functions as said first node in the new network.

8. An addressing method in a network so constructed that plural nodes each given a unique node identifier does not compose a logical loop, said addressing method comprising:
the first step of making each of said nodes store first information indicating all of said node identifiers used in said network and second information indicating said node identifiers of all of said nodes directly or indirectly connected to each port of own node; and
the second step at which, when new node are connected to said network, a first node previously selected out of said nodes connected to the network gives each of the new nodes said node identifier, and notifies the other nodes of this information to make the other nodes update said first and/or second information, and when said nodes are disconnected from the network, a prescribed second node remaining in the network notifies the other nodes of this information to make the other nodes update said first and/or second information.

9. The addressing method according to claim 8, wherein
each of said nodes stores said node identifiers which are used in said network as the presence of flags in storage regions provided in correspondence with said node identifiers previously set usable in the network.

10. The addressing method according to claim 8, wherein
each of said nodes stores said node identifiers of all of said nodes which are directly or indirectly connected to each port of own node as the presence of flags in storage regions provided in correspondence with said node identifiers previously set usable in the network.

11. The addressing method according to claim 8, wherein
at first, said first node is a root node determined in such a manner that a value obtained by adding the number of lower nodes connected to own node to one is given to the higher node as the number of connected nodes in an order from the lowest node of said network.

12. The addressing method according to claim 11, wherein
after determination of said root node, said node identifiers are sequentially assigned to lower said nodes directly connected to own node based on said number of connected nodes given from the lower nodes, in an order from the root node.

13. The addressing method according to claim 8, wherein
said second node is said node which was a disconnected end on said network side having said first node.

14. The addressing method according to claim 8, wherein
at said second step, said node which is disconnected from said network and is a disconnected end on a new network side without said first node functions as said first node in the new network.

15. A communication control device comprising:
first storage means for storing first information indicating all node identifiers used in the network to which own node is connected;
second storage means for storing second information indicating said node identifiers of all nodes directly or indirectly connected to each port of said own node;
control means for controlling communications with another node based on said first and second information; and
updating means for updating said first and/or second information in accordance with the connection of new nodes to said network or the disconnection of said nodes from said network.

16. The communication control device according to claim 15, wherein
said first storage means stores said node identifiers which are used in said network to which own node is connected as the presence of flags in storage regions provided in correspondence with said node identifiers previously set usable in the network.

17. The communication control device according to claim 15, wherein
said second storage means stores said node identifiers of all of said nodes which are directly or indirectly connected to said each port as the presence of flags in storage regions provided in correspondence with said node identifiers previously set usable in the network.

18. The communication control device according to claim 15, wherein
said updating means updates said first and/or second information based on notification given from a prescribed said node connected to said network.

19. A communication control method comprising:
the first step of storing first information indicating all node identifiers used in a network to which own node is connected and second information indicating said node identifiers of all of said nodes directly or indirectly connected to each port of said own node; and
the second step of controlling communications with another node based on said fist and second information and updating said first and/or second information in accordance with the connection of new nodes to said network or the disconnection of said nodes from the network.

20. The communication control method according to claim 19, wherein
at said first step, said node identifiers which are used in said network to which own node is connected are stored as the presence of flags in storage regions provided in correspondence with said node identifiers previously set usable in the network.

21. The communication control method according to claim 19, wherein
at said first step, said node identifiers of all of said nodes which are directly or indirectly connected to said each port are stored as the presence of flags in storage regions provided in correspondence with said node identifiers previously set usable in the network.

22. The communication control method according to claim 19, wherein
at said second step, said first and/or second information is updated based on notification given from a prescribed said node connected to said network.
